(19) United States
(12) Patent Application Publication
(10) Pub. No.: US 2024/0333334 A1
(43) Pub. Date: Oct. 3, 2024

(54) SWITCHING DEVICE AND COMMUNICATION SYSTEM

(71) Applicant: Icom Incorporated, Osaka (JP)

(72) Inventors: Shinichirou Adachi, Osaka (JP); Hiroki Nishino, Osaka (JP); Masaomi Kawashita, Osaka (JP)

(21) Appl. No.: 18/620,340

(22) Filed: Mar. 28, 2024

(30) Foreign Application Priority Data
Mar. 31, 2023 (JP) 2023-058585

(51) Int. Cl. H04B 1/44; H04B 7/06; H04B 7/08

(52) U.S. Cl. CPC H04B 1/44; H04B 7/0608; H04B 7/0805

(57) ABSTRACT

A switching device includes: a transmission path configured to transmit a transmission signal; a reception path configured to transmit a reception signal; a main-path switching part configured to perform switching of paths so as to connect one of two radio devices to the transmission path and connect the other of the two radio devices to the reception path; and a command output section configured to output a permission command that permits the radio device connected to the transmission path to perform transmission and configured to output a prohibition command that prohibits the radio device connected to the reception path from performing transmission.

This Nonprovisional application claims priority under 35 U.S.C. § 119 on Patent Application No. 2023-058585 filed in Japan on Mar. 31, 2023, the entire contents of which are hereby incorporated by reference.

### TECHNICAL FIELD

The present invention relates to, for example, a switching device configured to switch between transmission and reception of each of a plurality of radio devices.

### BACKGROUND ART

It is known that in a case where a plurality of radio devices are operated, a switching device is used. The switching device is for connecting an antenna to one radio device selected from among the plurality of connected radio devices. For example, Patent Literature 1 discloses a transmission circuit in which one of signals inputted into respective two signal input terminals is inputted to one antenna by switching, with use of a signal switch, between input paths in which the signals are transmitted via attenuators.

In the above transmission circuit, only a single radio device is connected to the antenna. Thus, in a case where a plurality of radio devices are used, only one radio device can be operated while the other radio devices cannot be operated. In addition, as an operation embodiment of amateur radio, single operator two radios (SO2R) in which two radio devices are used is known. In some amateur radio contests, transmitting two radio waves simultaneously in an operation embodiment of the SO2R may be taken as violation of rules. Thus, it is demanded that one radio device can perform transmission and reception while the other radio devices can perform only reception.

In response to such a demand, interlock devices are existing. The interlock devices control transmission operations (PTT operations) over a plurality of radio devices. Such interlock devices are disposed between a plurality of radio devices and their respective microphones and are configured to, while a transmission operation is performed through one of the microphones, reject the transmission operations through the other microphones. This enables only one radio device of the plurality of radio devices to perform transmission.

### CITATION LIST

### Patent Literature

[Patent Literature 1]
Japanese Patent Application Publication Tokukaihei No. 10-215128

### SUMMARY OF INVENTION

### Technical Problem

In order to set only one radio device of a plurality of radio devices to be usable for transmission, such interlock devices are needed. This unfortunately raises a problem that a system including such interlock devices has a complicated configuration, and the system costs much.

It is an object of an aspect of the present invention to set, with a simple configuration, only one radio device of a plurality of radio devices to be usable for transmission.

### Solution to Problem

In order to solve the foregoing problem, a switching device in accordance with an aspect of the present invention includes: a transmission path configured to transmit a transmission signal; a reception path configured to transmit a reception signal; a path switching part configured to perform switching of paths so as to connect one of a plurality of radio devices to the transmission path and connect another one of the plurality of radio devices to the reception path; and a transmission control section configured to output a permission signal that permits the radio device connected to the transmission path to perform transmission and configured to output a prohibition signal that prohibits the radio device connected to the reception path from performing transmission.

In order to solve the foregoing problem, a communication system in accordance with an aspect of the present invention includes: a plurality of radio devices; a plurality of antennas; and a switching device configured to perform switching of connections of (i) each of the plurality of radio devices and (ii) the plurality of antennas, the plurality of antennas being connected to the switching device in advance, the switching device including: a transmission path configured to transmit a transmission signal; a reception path configured to transmit a reception signal; a path switching part configured to perform switching of paths so as to connect one of the plurality of radio devices to the transmission path and connect another one of the plurality of radio devices to the reception path; a transmission control section configured to output a permission signal that permits the radio device connected to the transmission path to perform transmission and configured output a prohibition signal t prohibits the radio device connected to the reception path from performing transmission; and an antenna switching part configured to perform switching of the plurality of antennas so as to connect one of the plurality of antennas to the transmission path and connect another one of the plurality of antennas to the reception path, the plurality of radio devices being configured to be set, in response to the permission signal, to be usable for transmission and being configured to be set, in response to the prohibition signal, to be usable for only reception.

### Advantageous Effects of Invention

An aspect of the present invention makes it possible to set, with a simple configuration, only one radio device of a plurality of radio devices to be usable for transmission.

### BRIEF DESCRIPTION OF DRAWINGS

FIG. 1 is a block diagram illustrating a configuration of a communication system in accordance with an embodiment of the present invention.

FIG. 2 is a view illustrating a state in which a switching device of the communication system sets one of two radio devices to be usable for transmission and sets the other of the two radio devices to be unusable for transmission.

FIG. 3 is a view illustrating another state in which the switching device of the communication system sets one of the two radio devices to be usable for transmission and sets the other of the two radio devices to be unusable for transmission.

### DESCRIPTION OF EMBODIMENTS

### Embodiment

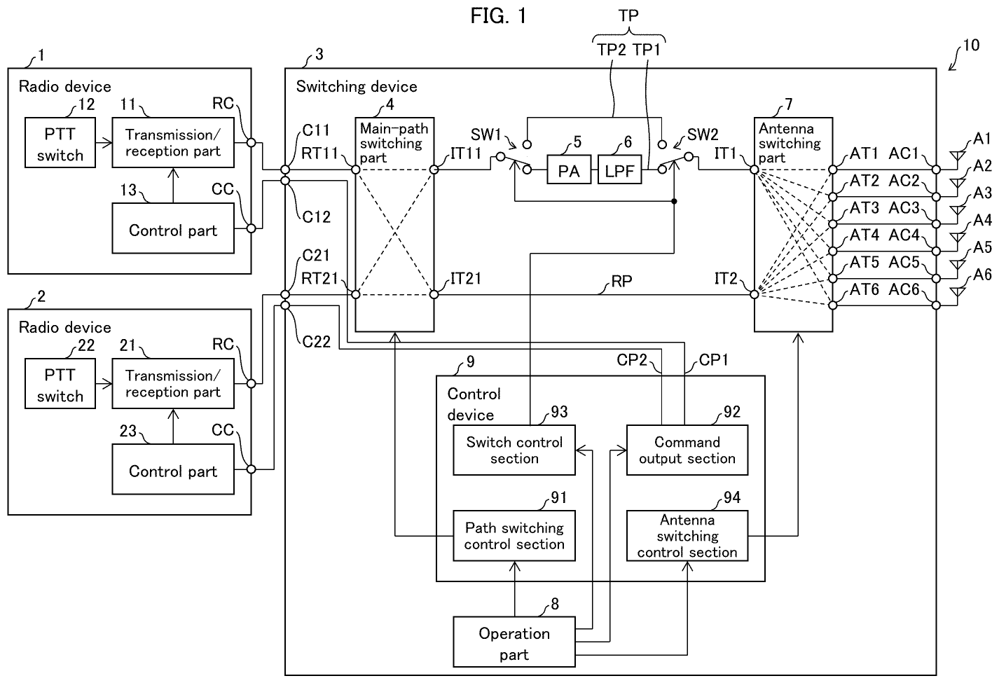

With reference to FIGS. 1 to 3, the following will describe an embodiment of the present invention.

### <Outline of Communication System>

FIG. 1 is a block diagram illustrating a configuration of a communication system 10 in accordance with the present embodiment.

The communication system 10 includes two radio devices 1 and 2, a switching device 3, and six antennas A1 to A6. The communication system 10 is configured to perform switching of connections of (i) each of the radio devices 1 and 2 and (ii) the antennas A1 to A6 with use of the switching device 3. In addition, the communication system 10 is configured to set, with use of the switching device 3, one of the radio devices 1 and 2 to be usable for transmission and set the other of the radio devices 1 and 2 to be unusable for transmission.

### <Configuration of Switching Device>

The switching device 3 includes main-path switching part 4 (path switching part), an amplifier 5 (abbreviated as “PA” in the drawings), a low-path filter 6 (abbreviated as “LPF” in the drawings), an antenna switching part 7, an operation part 8, a control device 9, and switches SW1 and SW2. Further, the switching device 3 includes, as signal paths, a transmission path TP, a reception path RP, a first control path CP1, and a second control path CP2. The transmission path TP is constituted by a first path TP1 and a second path TP2. Furthermore, the switching device 3 includes, as connectors to be connected to external devices, communication connectors C11 and C21, control connectors C12 and C22, and antenna connectors AC1 to AC6.

In order to enable transmission and reception of a transmission signal and a reception signal between the radio device 1 and the switching device 3, the communication connector C11 is connected to a communication cable for connecting the radio device 1 and the switching device 3 to each other. Meanwhile, in order to enable transmission and reception of a transmission signal and a reception signal between the radio device 2 and the switching device 3, the communication connector C21 is connected to a communication cable for connecting the radio device 2 and the switching device 3 to each other.

In order to enable output of a control command to the radio device 1, the control connector C12 is connected to a control cable for connecting the radio device 1 and the switching device 3 to each other. In order to enable output of a control command to the radio device 2, the control connector C22 is connected to a control cable for connecting the radio device 2 and the switching device 3 to each other.

The antenna connectors AC1 to AC6 are connected respectively to the antennas A1 to A6.

The main-path switching part 4 is a switching circuit configured to perform switching of communication transmission paths for transmitting a transmission signal and a reception signal. The main-path switching part 4 includes, as terminals on a radio device side, communication terminals RT11 and RT21 and includes, as terminals on an internal side (path side), communication terminals IT11 and IT21. The communication terminals RT11 and RT21 are connected respectively to the communication connectors C11 and C21.

The main-path switching part 4 includes a first communication transmission path, a second communication transmission path, a third communication transmission path, and a fourth communication transmission path. The first communication transmission path is a path for connecting the communication terminals RT11 and IT11 to each other. The second communication transmission path is a path for connecting the communication terminal RT21 and IT21 to each other. The third communication transmission path is a path for connecting the communication terminals RT11 and IT21 to each other. The fourth communication transmission path is a path for connecting the communication terminals RT21 and IT11 to each other. Each of the communication transmission paths is configured to transmit a transmission signal and a reception signal.

The main-path switching part 4 switches a connection each of mode of the communication transmission paths between a first connection mode and a second connection mode. In the first connection mode, the first communication transmission path and the second communication transmission are formed. In the path second connection mode, the third communication transmission path and the fourth communication transmission path are formed.

The switch SW1 is configured to switch between the connection of the communication terminal IT11 of the main-path switching part 4 and the first path TP1 and the connection of the communication terminal IT11 and the second path TP2. On the first path TP1, the amplifier 5 and the low-path filter 6 are disposed in this order from a switch SW1 side. The amplifier 5 is configured to amplify a transmission signal inputted into the amplifier 5 via the switch SW1. The low-path filter 6 transmits predetermined low-frequency components of the transmission signal that has been amplified by the amplifier 5. The switch SW2 is configured to switch between the connection of a communication terminal IT1 (described later) of the antenna switching part 7 and the first path TP1 and the connection of the communication terminal IT1 and the second path TP2. The switches SW1 and SW2 perform the switching operations in conjunction with each other and are both connected either one of the first path TP1 and the second path TP2.

The reception path RP is a path for transmitting a reception signal. The reception path RP connects the communication terminal IT21 of the main-path switching part 4 and a communication terminal IT2 (described later) of the antenna switching part 7 to each other.

The antenna switching part 7 is configured to perform switching of the connections of the transmission path TP and the antennas A1 to A6 and perform switching of the connections of the reception path RP and the antennas A1 to A6. The antenna switching part 7 includes, as terminals on the internal side (path side), communication terminals IT1 and IT2 and includes, as terminals on an antenna side, antenna terminals AT1 to AT6. The antenna terminals AT1 to AT6 are connected respectively to the antenna connectors AC1 to AC6. The communication terminal IT1 is connected to a common terminal of the switch SW2. As described above, the communication terminal IT2 is connected to the reception path RP.

The antenna switching part 7 performs switching of connection paths so as to connect the communication terminal IT1 to one of the antenna terminals AT1 to AT6. Further, the antenna switching part 7 performs switching of the connection paths so as to connect the communication terminal IT2 to one of the antenna terminals AT1 to AT6 except the antenna connected to the communication terminal IT1.

The operation part 8 is disposed at a front panel (not illustrated) of the switching device 3. In order to receive an operation from a user, the operation part 8 has an input device, such as a touch panel or operation buttons. In particular, the operation part 8 is configured so as to make it possible to select either one of the first connection mode described above and the second connection mode described above with use of the input device. Further, the operation part 8 is configured so as to make it possible to select either one of the first path TP1 and the second path TP2 with use of the input device. Furthermore, the operation part 8 is configured so as to make it possible to select, with use of the input device, the antenna to be connected to each of the transmission path TP and the reception path RP.

When an operation has been performed for selecting, as a connection mode, either one of the first connection mode and the second connection mode, the operation part 8 outputs, to the control device 9, a mode selection signal indicating the connection mode selected. When an operation has been performed for selecting either one of the first path TP1 and the second path TP2, the operation part 8 outputs a path selection signal to the control device 9. When an operation has been performed for selecting the antenna to be connected to the transmission path TP and the antenna to be connected to the reception path RP from among the antennas A1 to A6, the operation part 8 outputs an antenna selection signal to the control device 9.

The control device 9 is configured to control targets to be controlled of the switching device 3, in particular, control the switching of the paths and the switching of the antennas. Further, the control device 9 is configured to output control commands to the radio devices 1 and 2. In order to achieve such functions, the control device 9 includes a path switching control section 91, a command output section 92 (transmission control section), a switch control section 93, and an antenna switching control section 94.

The path switching control section 91 is configured to output a mode switching signal to the main-path switching part 4 on the basis of the mode selection signal from the operation part 8. The mode switching signal is a signal for instructing the main-path switching part 4 to switch between the first connection mode and the second connection mode.

The command output section 92 outputs control commands in accordance with the mode selection signal from the operation part 8 indicating selection of the first connection mode. Specifically, the command output section 92 outputs a transmission permission command CMDOK (permission signal) to the first control path CP1 and outputs a transmission prohibition command CMDNG (prohibition signal) to the second control path CP2. On the other hand, in accordance with the mode selection signal from the operation part 8 indicating the selection of the second connection mode, the command output section 92 outputs the transmission permission command CMDOK to the second control path CP2 and outputs the transmission prohibition command CMDNG to the first control path CP1. The first control path CP1 is connected to the control connector C12. The second control path CP2 is connected to the control connector C22.

The switch control section 93 is configured to output, to the switches SW1 and SW2, operation signals for causing an operation of switching between the switches SW1 and SW2, on the basis of the path selection signal from the operation part 8. The antenna switching control section 94 is configured to output an antenna switching signal to the antenna switching part 7 on the basis of the antenna selection signal from the operation part 8.

### <Configuration of Radio Device>

The radio devices 1 and 2 each can handle, for example, a frequency within a frequency band usable for transmitting/receiving an audio signal via amateur radio and thus each can be used as an amateur radio device. Note, however, that use embodiments of the radio devices 1 and 2 are not limited to amateur radio devices. The radio devices 1 and 2 respectively include transmission/reception parts 11 and 21, Push to Talk (PTT) switches 12 and 22, and control parts 13 and 23. Further, the radio devices 1 and 2 each include a communication connector RC and a control connector CC.

The transmission/reception parts 11 and 21 are each configured to perform a transmission process and a reception process. The PTT switches 12 and 22 are attached to respective microphones (not illustrated) provided to the radio devices 1 and 2 and are operated by a user at the time of transmission. The transmission/reception parts 11 and 21 perform transmission processes when the PTT switches 12 and 22 are operated, and performs reception processes when the PTT switches 12 and 22 are not operated.

The transmission/reception parts 11 and 21 are configured to, via the communication connectors RC, output transmission signals and receive reception signals. The communication connector RC of the radio device 1 is connected to the communication connector C11 of the switching device 3. The communication connector RC of the radio device 2 is connected to the communication connector C21 of the switching device 3.

The control parts 13 and 23 are configured to control the transmission/reception parts 11 and 21, respectively. Into the control parts 13 and 23, control commands are inputted via the control connectors CC. The control connector CC of the radio device 1 is connected to the control connector C12 of the switching device 3. The control connector CC of the radio device 2 is connected to the control connector C22 of the switching device 3.

Each of the control parts 13 and 23 sets a usable-for-transmission flag when receiving the transmission permission command CMDOK as a control command from the command output section 92, and sets an unusable-for-transmission flag when receiving the transmission prohibition command CMDNG as the control command. The control parts 13 and 23 are configured to, on the basis of the usable-for-transmission flags, output transmission permission instructions to the transmission/reception parts 11 and 21, respectively. The control parts 13 and 23 are configured to, on the basis of the unusable-for-transmission flags, output transmission prohibition instructions to the transmission/reception parts 11 and 21, respectively.

The transmission/reception parts 11 and 21 enable operation signals from the PTT switches 12 and 22 on the basis of the transmission permission instructions from the control parts 13 and 23, respectively, so that the radio devices 1 and 2 are set to be in usable-for-transmission states. Further, the transmission/reception parts 11 and 21 disable operation signals from the PTT switches 12 and 22 on the basis of the transmission prohibition instructions from the control parts 13 and 23, respectively, so that the radio devices 1 and 2 are set to be in unusable-for-transmission states in which only reception can be performed.

### <Transmission/Reception Switching Operation by Switching Device>

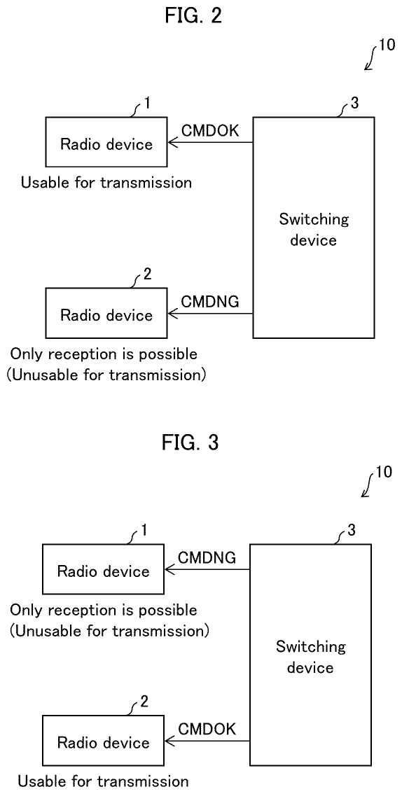

FIG. 2 is a view illustrating a state in which the switching device 3 of the communication system 10 sets one of the two radio devices 1 and 2 to be usable for transmission and sets the other of the two radio devices 1 and 2 to be unusable for transmission. FIG. 3 is a view illustrating another state in which the switching device 3 of the communication system 10 sets one of the two radio devices 1 and 2 to be usable for transmission and sets the other of the two radio devices 1 and 2 to be unusable for transmission.

In a case where an operation for selecting the first connection mode has been performed through the operation part 8, the path switching control section 91 outputs a mode switching signal indicating switching to the first connection mode. In response to the mode switching signal, the main-path switching part 4 forms the first communication transmission path and the second communication transmission path. This causes the radio device 1 to be connected to the transmission path TP via the first communication transmission path of the main-path switching part 4. Further, this causes the radio device 2 to be connected to the reception path RP via the second communication transmission path of the main-path switching part 4.

On the basis of the mode selection signal from the operation part 8, the command output section 92 outputs the transmission permission command CMDOK to the first control path CP1 and outputs the transmission prohibition command CMDNG to the second control path CP2.

In this state, as illustrated in FIG. 2, the transmission permission command CMDOK outputted from the command output section 92 of the switching device 3 is inputted into the radio device 1, and the transmission prohibition command CMDNG outputted from the command output section 92 is inputted into the radio device 2. This causes the radio device 1 to enable the PTT switch 12 and to be set to a usable-for-transmission state. Further, this causes the radio device 2 to disable the PTT switch 22 and to be set to an unusable-for-transmission state in which only reception can be performed.

In a case where an operation for selecting the second connection mode has been performed through the operation part 8, the path switching control section 91 outputs a mode switching signal indicating switching to the second connection mode. In response to the mode switching signal, the main-path switching part 4 forms the third communication transmission path and the fourth communication transmission path. This causes the radio device 1 to be connected to the reception path RP via the third communication transmission path of the main-path switching part 4. Further, this causes the radio device 2 to be connected to the transmission path TP via the fourth communication transmission path of the main-path switching part 4.

On the basis of the mode selection signal from the operation part 8, the command output section 92 outputs the transmission prohibition command CMDNG to the first control path CP1 and outputs the transmission permission command CMDOK to the second control path CP2.

In this state, as illustrated in FIG. 3, the transmission prohibition command CMDNG outputted from the command output section 92 is inputted into the radio device 1, and the transmission permission command CMDOK outputted from the command output section 92 is inputted into the radio device 2. This causes the radio device 1 to disable the PTT switch 12 and to be set to an unusable-for-transmission state in which only reception can be performed. Further, this causes the radio device 2 to enable the PTT switch 22 and to be set to a usable-for-transmission state.

<Transmission Path Switching Operation by Switching Device>

In a case where an operation for selecting the first path TP1 has been performed through the operation part 8, the switch control section 93 outputs an operation signal indicating connection to the first path TP1. In response to the operation signal, the switch SW1 connects the communication terminal IT11 of the main-path switching part 4 to the first path TP1. In addition, in response to the operation signal, the switch SW2 connects the first path TP1 to the communication terminal IT1 of the antenna switching part 7. Thus, a transmission signal that has passed the main-path switching part 4 is led to the first path TP1. The transmission signal is then subjected to an amplification process by the amplifier 5 and a filtering process by the low-path filter 6, and is outputted to the antenna switching part 7.

In a case where an operation for selecting the second path TP2 has been performed through the operation part 8, the switch control section 93 outputs an operation signal indicating connection to the second path TP2. In response to the operation signal, the switch SW1 connects the communication terminal IT11 of the main-path switching part 4 to the second path TP2. In addition, in response to the operation signal, the switch SW2 connects the second path TP2 to the communication terminal IT1 of the antenna switching part 7. Thus, a transmission signal that has passed the main-path switching part 4 is led to the antenna switching part 7 via the second path TP2.

### <Antenna Switching Operation by Switching Device>

In a case where, for example, an operation for connecting the transmission path TP to the antenna A1 has been performed through the operation part 8, the antenna switching control section 94 outputs an antenna selection signal indicating connection of the communication terminal IT1 to the antenna terminal AT1. In response to the antenna selection signal, the antenna switching part 7 connects the communication terminal IT1 to the antenna terminal AT1. In a case where an operation has been performed for connecting the reception path RP to the antenna A2, the antenna switching control section 94 outputs an antenna selection signal indicating connection of the communication terminal IT2 to the antenna terminal AT2. In response to the antenna selection signal, the antenna switching part 7 connects the communication terminal IT2 to the antenna terminal AT2.

### Effects of Embodiment

The communication system 10 in accordance with the present embodiment includes the radio devices 1 and 2, the antennas A1 to A6, and the switching device 3 configured to perform switching of connections of (i) each of the radio devices 1 and 2 and (ii) the antennas A1 to A6. The switching device 3 includes the transmission path TP, the reception path RP, the first control path CP1, the second control path CP2, the main-path switching part 4, and the command output section 92. The main-path switching part 4 is configured to perform switching of paths so as to connect one of the radio devices 1 and 2 to the transmission path TP and connect the other of the radio devices 1 and 2 to the reception path RP. The command output section 92 is configured to output the transmission permission command CMDOK to the radio device 1 or 2 connected to the transmission path TP and output the transmission prohibition command CMDNG to the radio device 1 or 2 connected to the reception path RP.

According to the above configuration, the transmission permission command CMDOK from the command output section 92 is supplied, via the first control path CP1, to, for example, the radio device 1 connected to the transmission path TP. Meanwhile, the transmission prohibition command CMDNG is supplied, via the second control path CP2, to, for example, the radio device 2 connected to the reception path RP.

This allows the radio device 1 connected to the transmission path TP to control itself, on the basis of the transmission permission command CMDOK, so as to be usable for transmission. Meanwhile, this allows the radio device 2 connected to the reception path RP to control itself, on the basis of the transmission prohibition command CMDNG, so as to be unusable for transmission, that is, to be capable of performing only reception. Therefore, it is possible to set, without the interlock device as described above, one of the radio devices 1 and 2 to be usable for transmission and set the other of the radio devices 1 and 2 to be capable of performing only reception.

In a case where a reception function is imparted to a transmission circuit as disclosed in Patent Literature 1, which is dedicated to transmission, so as to allow the transmission circuit to perform both transmission and reception, the transmission circuit is provided with a reception circuit. In this case, an operation needs to be manually performed for switching such that (i) in a case where a radio device for transmission is connected to the reception circuit, the radio device for transmission is connected to the transmission circuit and (ii) in a case where a radio device for reception is connected to the transmission circuit, the radio device for reception is connected to the reception circuit. Unfortunately, this raises a problem that if the switching is incorrectly performed, a transmission signal is inputted into the reception circuit, resulting in damage to the reception circuit.

In contrast, the communication system 10 sets only the radio device connected to the transmission path TP to be usable for transmission, and thus does not raise such a problem.

The switching device 3 includes the antenna switching part 7 configured to perform switching of the antennas A1 to A6 so as to connect one of the antennas A1 to A6 to the transmission path TP and connect another one of the antennas A1 to A6 to the reception path RP, the antennas A1 to A6 being connected to the switching device 3 in advance

According to the above configuration, it is possible to connect one device of the radio devices 1 and 2, which is usable for transmission, to an antenna suitable for a frequency band for transmission and to connect the other device of the radio devices 1 and 2, which is unusable for transmission, to an antenna suitable for a frequency band for reception.

The switching device 3 further includes the amplifier 5 configured to amplify a transmission signal being transmitted in the transmission path TP.

According to the above configuration, it is possible to increase a transmission distance by amplifying the transmission signal.

### <Variation>

In the above embodiment, a configuration is described in which the communication system 10 includes the two radio devices 1 and 2, but this should not be construed as a limitation. The communication system 10 may include three or more radio devices. Further, the transmission path TP may transmit not only a transmission signal but also a reception signal. Furthermore, the communication system 10 is configured to be connectable with the six antennas A1 to A6 at most but alternatively may be configured to be connectable with seven or more antennas.

The radio devices 1 and 2 described above are configured to perform transmission through operations of the PTT switches 12 and 22, but this should not be construed as a limitation. The radio devices 1 and 2 may be configured to further perform other transmission operations. Such radio devices 1 and 2 are configured to enable the transmission operations on the basis of transmission permission instructions from the control parts 13 and 23, respectively and are configured to disable the transmission operations on the basis of transmission prohibition instructions from the control parts 13 and 23, respectively.

### [Software Implementation Example]

Functions of the switching device 3 can be realized by a program for causing a computer to function as the switching device 3. The program causes the computer to function as control blocks (in particular, the path switching control section 91, the command output section 92, the switch control section 93, and the antenna switching control section 94) of the control device 9 of the switching device 3.

In this case, the control device 9 includes, as hardware for executing the program, at least one CPU and at least one main memory. The functions described in the above embodiments are realized by executing the program with use of the CPU and the main memory.

The program can be stored in one or more non-transitory computer-readable storage media. The one or more storage media may be included in the switching device 3 or may not be included in the switching device 3. In the latter case, the program can be supplied to or made available to the switching device 3 via any wired or wireless transmission medium.

Further, part or all of the functions of the control blocks of the control device 9 can also be realized by a logic circuit. For example, an integrated circuit in which a logic circuit functioning as the control blocks is formed is included in the scope of the present invention.

### [Supplementary Note]

The present invention is not limited to the embodiments, but can be altered by a person skilled in the art within the scope of the claims. The present invention also encompasses, in its technical scope, any embodiment derived by combining technical means disclosed in differing embodiments.

### REFERENCE SIGNS LIST

1, 2 Radio device
3 Switching device
4 Main-path switching part (path switching part)
7 Antenna switching part
10 Communication system
92 Command output section (transmission control section)
A1 to A6 Antenna
CP1 First control path
CP2 Second control path
TP Transmission path
RP Reception path
CMDOK Permission command (permission signal)
CMDNG Prohibition command (prohibition signal)

1. A switching device comprising:
a transmission path configured to transmit a transmission signal;
a reception path configured to transmit a reception signal;
a path switching part configured to perform switching of paths so as to connect one of a plurality of radio devices to the transmission path and connect another one of the plurality of radio devices to the reception path; and
a transmission control section configured to output a permission signal that permits the radio device connected to the transmission path to perform transmission and configured to output a prohibition signal that prohibits the radio device connected to the reception path from performing transmission.

2. The switching device according to claim 1, further comprising an antenna switching part configured to perform switching of a plurality of antennas so as to connect one of the plurality of antennas to the transmission path and connect another one of the plurality of antennas to the reception path,
the plurality of antennas being connected to the switching device in advance.

3. The switching device according to claim 1, further comprising an amplifier configured to amplify the transmission signal being transmitted in the transmission path.

4. A communication system comprising:
a plurality of radio devices;
a plurality of antennas; and
a switching device configured to perform switching of connections of (i) each of the plurality of radio devices and (ii) the plurality of antennas,
the plurality of antennas being connected to the switching device in advance,
the switching device including:
a transmission path configured to transmit a transmission signal;
a reception path configured to transmit a reception signal;
a path switching part configured to perform switching of paths so as to connect one of the plurality of radio devices to the transmission path and connect another one of the plurality of radio devices to the reception path;
a transmission control section configured to output a permission signal that permits the radio device connected to the transmission path to perform transmission and configured to output a prohibition signal that prohibits the radio device connected to the reception path from performing transmission; and
an antenna switching part configured to perform switching of the plurality of antennas so as to connect one of the plurality of antennas to the transmission path and connect another one of the plurality of antennas to the reception path,
the plurality of radio devices being configured to be set, in response to the permission signal, to be usable for transmission and being configured to be set, in response to the prohibition signal, to be usable for only reception.

5. The communication system according to claim 4, wherein the switching device further includes an amplifier configured to amplify the transmission signal being transmitted in the transmission path.
